(19) United States
(12) Patent Application Publication
(10) Pub. No.: US 2010/0241955 A1
(43) Pub. Date: Sep. 23, 2010

(54) ORGANIZATION AND MANIPULATION OF CONTENT ITEMS ON A TOUCH-SENSITIVE DISPLAY

(75) Inventors: Edward Price, Redmond, WA (US); Nicole Coddington, Kirkland, WA (US); Derek Sunday, Renton, WA (US); Ron George, Kirkland, WA (US); Daniel John Makoski, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/409,388

(22) Filed: Mar. 23, 2009

(51) Int. Cl. G06F 3/01

(52) U.S. Cl. 715/702

(57) ABSTRACT

Embodiments related to the manipulation of content items on a touch sensitive display are disclosed. One disclosed embodiment comprises a method for operating a graphical user interface on a computing device comprising a touch-sensitive display. The method comprises displaying a content container on the touch-sensitive display, the content container being configured to arrange one or more content items in the content container as a grouped set of content items and to allow a user to selectively move content items into and out of the content container. The method further comprises displaying an ungrouped set of content items on the touch-sensitive display outside of the content container, receiving a user input via a user interface associated with the content container, and in response to the user input, highlighting a content item in the ungrouped set of content items to form a highlighted ungrouped content item.

### BACKGROUND

Graphical user interfaces for computing devices are increasing being utilized to provide more natural, intuitive interactions with content. For example, some graphical user interfaces configured to be used with a touch-sensitive display input device may allow a user to move a virtual object by touching the display over the virtual object and then moving the touch to drag the object across the display, and/or to scroll through a list displayed on the display by flicking an item located on the display to cause a similar inertial motion as would occur if a physical object were flicked in a similar manner. Likewise, content may be displayed in a similarly natural, real-world manner. For example, a collection of photographs may be displayed as a pile or scattering of larger images, instead of as a grid or list of icons or thumbnails.

The use of modern touch-sensitive displays for interaction with a graphical user interface has allowed the development of intuitive gestures to be used to interact with an interface. However, current methods to organize, display and manipulate content on such touch-sensitive displays may use organizational techniques developed for pointer-based graphical user interfaces, and may not fully utilize the capabilities of modern touch-sensitive display technology. Further, creating advanced Natural User Interfaces (NUIs) for such graphical user interfaces may pose daunting programming challenges.

### SUMMARY

Accordingly, various embodiments related to the manipulation of contents items on a touch-sensitive display are disclosed. For example, one disclosed embodiment provides a method for operating a graphical user interface on a computing device comprising a touch-sensitive display. The method comprises displaying a content container on the touch-sensitive display, the content container being configured to arrange one or more content items in the content container as a grouped set of content items and to allow a user to selectively move content items into and out of the content container. The method further comprises displaying an ungrouped set of content items on the touch-sensitive display outside of the content container, receiving a user input via a user interface associated with the content container, and in response to the user input, highlighting a content item in the ungrouped set of content items.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a computing device including a touch-sensitive display.

FIG. 2 illustrates an uploading of content items onto a computing device.

FIG. 3 illustrates an embodiment of a formation of a content container on a graphical user interface of the computing device, and also illustrates a stacked configuration of content shown in the content container.

FIGS. 4-5 illustrate another embodiment of a formation of a content container.

FIG. 6 illustrates a grid configuration of the grouped set of items in the content container of FIG. 3.

FIGS. 7-9 show a selection and movement of a content item from a location inside of the content container to a location outside of the content container when the content container is in a stacked configuration.

FIGS. 10-12 illustrate an embodiment showing a selection and movement of a content item from a location inside of the content container to a location outside of the content container when the content container is in a grid configuration.

FIG. 13-14 illustrate an embodiment of a highlighting of a content item outside the content container via a user interaction with the content container.

FIG. 15-16 illustrate another embodiment of a highlighting of a content item outside of the content container via a user interaction with the content container.

FIG. 17-18 illustrate an embodiment of a highlighting of a plurality of content items via a user interaction with the content container.

FIG. 19 shows a process flow depicting a method for operating a graphical user interface on a computing device.

### DETAILED DESCRIPTION

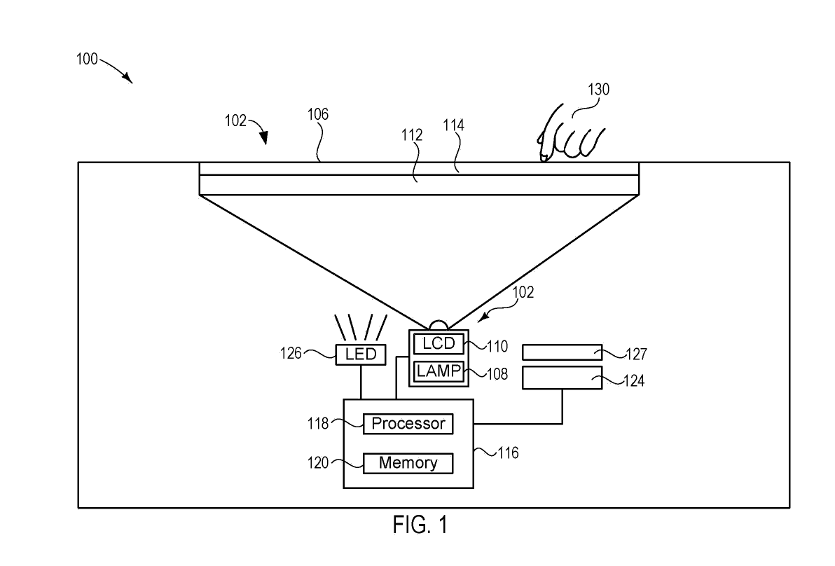

Prior to discussing the organization and manipulation of content items on a touch-sensitive display, an embodiment of an example computing device including a touch-sensitive display is described. FIG. 1 shows a schematic depiction of an embodiment a surface computing device 100 comprising a touch-sensitive display 102. The touch-sensitive display 102 comprises a projection display system having an image source 104, and a display screen 106 onto which images are projected. While shown in the context of a projection display system, it will be appreciated that the embodiments described herein may also be implemented with other suitable display systems, including but not limited to LCD panel systems.

The image source 104 includes a light source 108 such as a lamp (depicted), an LED array, or other suitable light source. The image source 104 also includes an image-producing element 110 such as the depicted LCD (liquid crystal display), an LCOS (liquid crystal on silicon) display, a DLP (digital light processing) display, or any other suitable image-producing element.

The display screen 106 includes a clear, transparent portion 112, such as sheet of glass, and a diffuser screen layer 114 disposed on top of the clear, transparent portion 112. As depicted, the diffuser screen layer 114 acts as a touch surface. In other embodiments, an additional transparent layer (not shown) may be disposed over diffuser screen layer 114 as a touch surface to provide a smooth look and feel to the display surface. Further, in embodiments that utilize a LCD panel rather than a projection image source to display images on display screen 106, the diffuser screen layer 114 may be omitted.

Continuing with FIG. 1, the touch-sensitive display 102 further includes an electronic controller 116 comprising a processor 118 and a memory 120. It will be understood that memory 120 may comprise code stored thereon that is executable by the processor 118 to control the various parts of computing device 100 to effect the methods described herein.

To sense objects placed on display screen 106, the touch-sensitive display 102 includes an image sensor 124 configured to capture an image of the entire backside of display screen 106, and to provide the image to electronic controller 116 for the detection of objects appearing in the image. The diffuser screen layer 114 helps to avoid the imaging of objects that are not in contact with or positioned within a few millimeters of display screen 106. Because objects that are close to but not touching the display screen 106 may be detected by image sensor 124, it will be understood that the term “touch” as used herein also may comprise near-touch inputs.

The image sensor 124 may include any suitable image sensing mechanism. Examples of suitable image sensing mechanisms include but are not limited to CCD and CMOS image sensors. Further, the image sensing mechanisms may capture images of display screen 106 at a sufficient frequency to detect motion of an object across display screen 106. While the embodiment of FIG. 1 shows one image sensor, it will be appreciated that more than one image sensor may be used to capture images of display screen 106.

The image sensor 124 may be configured to detect light of any suitable wavelength, including but not limited to infrared and visible wavelengths. To assist in detecting objects placed on display screen 106, the image sensor 124 may further include an illuminant 126 such as one or more light emitting diodes (LEDs) configured to produce infrared or visible light to illuminate a backside of display screen 106. Light from illuminant 126 may be reflected by objects placed on display screen 106 and then detected by image sensor 124. Further, an infrared band pass filter 127 may be utilized to pass light of the frequency emitted by the illuminant 126 but prevent light at frequencies outside of the band pass frequencies from reaching the image sensor 124, thereby reducing the amount of ambient light that reaches the image sensor 124.

While described herein in the context of an optical touch-sensitive system, the embodiments described herein also may be used with any other suitable type of touch-sensitive input system and with any suitable type of computing device. Examples of other such systems include, but are not limited to, capacitive and resistive touch-sensitive inputs. Further, while depicted schematically as a single device that incorporates the various components described above into a single unit, it will be understood that the touch-sensitive display 102 also may comprise a plurality of discrete physical parts or units connected as a system by cables, wireless connections, network connections, etc. It will be understood that the term “computing device” may include any device that electronically executes one or more programs, such as a user interface program. Such devices may include, but are not limited to, personal computers, laptop computers, servers, portable media players, hand-held devices, cellular phones, and microprocessor-based programmable consumer electronic and/or appliances.

FIG. 1 also depicts a hand 130 with a finger placed on display screen 106. Light from the illuminant 126 reflected by the finger may be detected by image sensor 124, thereby allowing the touch of the finger to be detected on the screen. While shown in the context of a finger, it will be understood that any other suitable manipulator or manipulators (e.g. one or more styluses, paint brushes, etc.) may be used to interact with computing device 100.

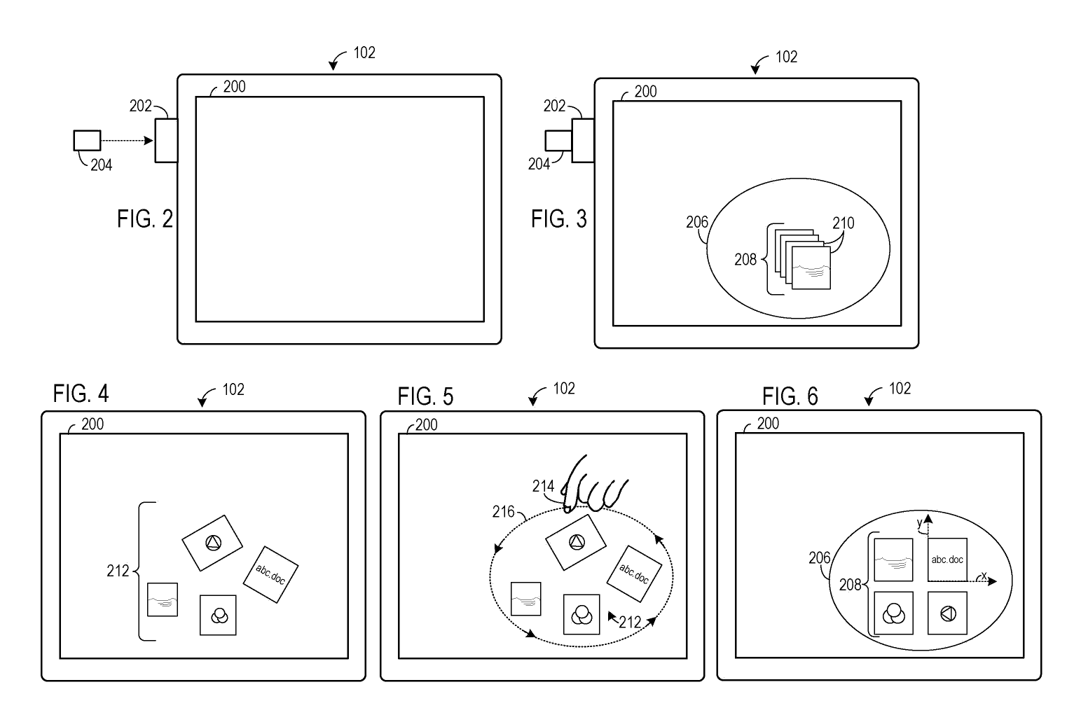

FIG. 2 illustrates an embodiment of a graphical user interface 200 that may be displayed on touch-sensitive display 102. The graphical user interface may include but is not limited to, one or more windows, one or more menus, a desktop region, etc. In this embodiment the touch-sensitive display is coupled to an input port 202. However, in other embodiments, the input port may not be coupled to the touch-sensitive display. Further in this embodiment, the input port may be coupled to the processor 118, illustrated in FIG. 1. Continuing with FIG. 2, the input port 202 may include one or more of a memory card slot, a Universal Serial Bus (USB) port, a Compact Disk Read Only Memory (CD-Rom) drive, a Digital Versatile Disc (DVD) drive, etc. A user may insert a data storage device 204, such as memory card, a USB drive, CD-Rom, DVD, etc., into the input port 202. The data storage device 204 may include content items, such as video content, image content, documents, text files, programs, web pages, etc. These content items may be represented by graphical elements on the graphical user interface that, in some embodiments, may be direct representations of the content. For example, image content may include a displayed image on a graphical user interface. Additionally, the graphical elements may include abstract representation of the content item, such as graphical icons.

Upon insertion of the data storage device 204 a content container 206 may be generated, as illustrated in FIG. 3, to display at least a portion of the uploaded content as a grouped set of content items 208. In this way, a user may quickly upload content onto the graphical user interface 200 for organization and manipulation. It will be appreciated that the content items may be uploaded onto the graphical user interface in any other suitable manner, such as from a folder or file directory within the computing device, from another computing device, from a wireless input device, etc. A boarder of the content container may be displayed via graphical elements, such as a geometric pattern (e.g. ellipse, circle, square, etc.), a line, etc. However, in other embodiments, the boarder of the content container may not be displayed.

The content items may be arranged in any suitable manner in the content container 206, including but not limited to a stacked arrangement and a grid arrangement. FIG. 3 illustrates the grouped set of content items 208 arranged in a stacked configuration within the content container 206, while FIG. 6 (discussed below) shows a grid configuration. Referring to FIG. 3, the stacked configuration includes two or more vertically offset content items 220 arranged according to an assigned z-order. It will be appreciated that in other embodiments, the content items in the stacked configuration may not be vertically offset. The z-order may be randomly assigned to each content item or alternatively may be assigned according to various parameters, which may include one or more of a date of creation, location, content type, etc.

Content items arranged in the stacked configuration may be scrolled via a touch input (not shown), wherein scrolling comprises revealing a next-lowest content item in a stack by adjusting a z-order of the stack. Example of suitable touch inputs include, but are not limited to, a tapping type touch input. The tapping type touch input may comprise touching the touch-sensitive display, via a digit or other manipulator, for a brief period of time after which the digit or manipulator is removed from the touch-sensitive display. However, in other embodiments, alternate approaches may be used to scroll through the grouped set of content items 208, such as a flicking type touch gesture, adjustment of a scrollbar, etc.

FIGS. 4-5 illustrates another way in which the content container may be generated. Specifically FIG. 4 illustrate a plurality of content items 212 scattered on the graphical user interface 200 and FIG. 5 illustrates an example touch gesture which may be performed by a user to create a content container 206, illustrated in FIG. 6, within the graphical user interface 200. Continuing with FIG. 5, to initiate the touch gesture a user may touch the display with a digit 214, or other manipulator, and then move the digit or manipulator around one or more content items, substantially circumscribing the content items 212, as indicated by path 216. In this way content items may be quickly organized via an intuitive touch gesture. It will be appreciated that alternate or additional touch gestures or touch inputs may be used to create the content container 206.

After the touch gesture has been performed the content container 206 is generated, as shown in FIG. 6. In this embodiment, the grouped set of content items 208 arranged in a grid configuration within the content container 206 on the graphical user interface 200. In particular, the content items within the grouped set of content items 208 have horizontally and vertically aligned axes. That is to say that the x and y coordinate axes of each content item within the grouped set of content items are aligned. However, it will be appreciated that alternate or additional geometric parameters may be used to arrange the grouped set of content items, in other embodiments. For example, the content items may be arranged in a column or a row.

Additionally, in some embodiments a user may toggle between the various arrangements (e.g. grid configuration, stacked configuration), allowing the content container to be easily adapted. Toggling may be initiated via a touch input, touch gesture, or in any other suitable manner.

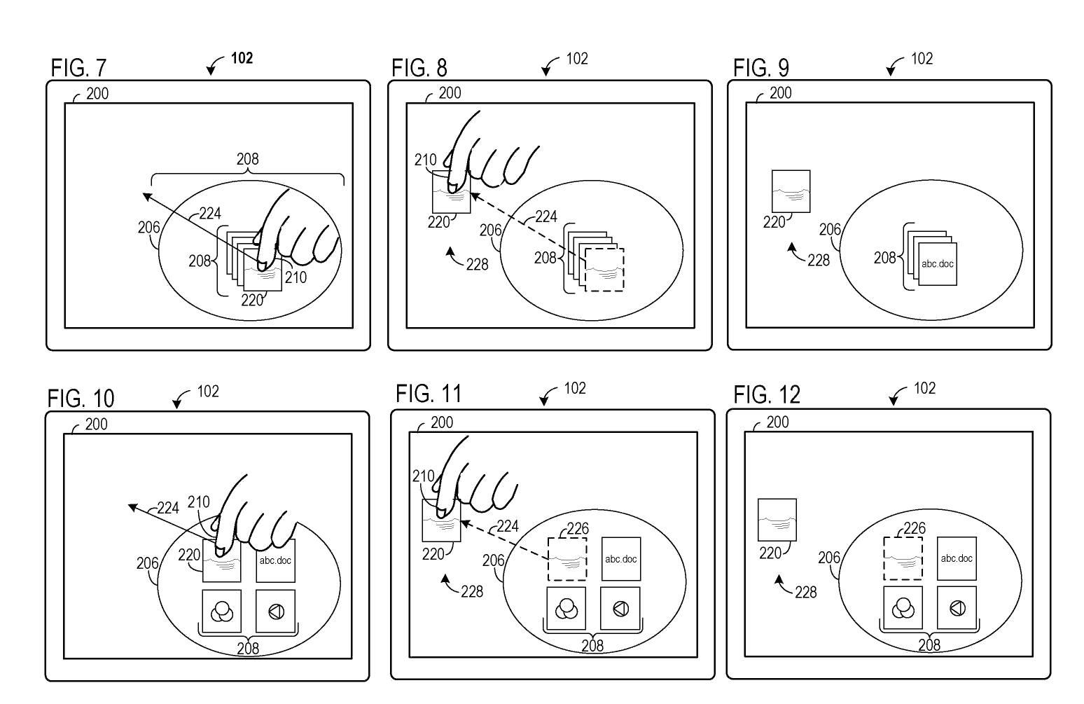

A user may want to move one or more content items outside of the content container 206, for example, to edit, manipulate, resize, etc. a content item. Therefore as illustrated in FIGS. 7-9, a user may request movement of a selected content item 220, via an input, to a location outside of the content container 206, on the graphical user interface 200. The input may be received via a user interface associated with the content container 206. For example, the input may be received directly over a content item, or via a contextual menu configured to perform an operation on content items contained within the content container 206. In the depicted embodiment, the input comprises a touch gesture. To initiated the touch gesture a user may touch an area above or proximate to the content item 220 on the touch-sensitive display 102, thereby selecting the content item 220, and drag via a fluid movement, as indicated by arrow 224, the selected content item outside of the content container 206, as illustrated in FIG. 7. However, it will be appreciated that any other suitable inputs may be used to select and move a content item outside of the content container 206.

In response to the touch gesture, the selected content item 220 may be moved to a location outside of the content container 206, as illustrated in FIG. 8. FIG. 9 illustrates the graphical user interface 200 subsequent to movement of the selected content item 220. The term “ungrouped set of content items” 228 as used herein refers to content items 220 located outside of an organizational container, and may include a plurality of items.

FIGS. 10-12 illustrates another embodiment of the movement of a content item to a location outside of the content container 206. In this embodiment, the grouped set of content items 208 are arranged in a grid configuration, and a touch “drag and drop” input is used to move the selected content item 220. In this embodiment, a proxy view 226 of the selected content item is displayed within the container after the selected content item 220 has been moved outside of the content container 206. The proxy view indicates to a user that the selected content item 220 has been moved out of the content container 206, and may have a different appearance than the other content items in the content container 206, as described in more detail below.

First, FIG. 10 illustrates initiation of the touch gesture to select and move the content item 220 outside of the content container 206. However, as previously discussed, alternate inputs may be utilized. In response to the touch gesture, the selected content item 220 may be moved to a location outside of the content container 206, as shown in FIG. 11. In some embodiments, the size and/or geometry of the selected content item 220 may be adjusted when the content item is placed outside of the content container 206. The selected content item may be included in the ungrouped set of content items 228.

Next, FIG. 12 illustrates the graphical user interface 200 after the movement of the selected content item 220. In particular, the proxy view 226 of the selected content item 220 within the content container 206 is displayed. As depicted, in some embodiments, the proxy view 226 of the selected content item may comprise an alteration of one or more of an opacity, saturation, and/or brightness than the corresponding selected content item 220 displayed outside of the content container 206 and/or the other content items located in the content container.

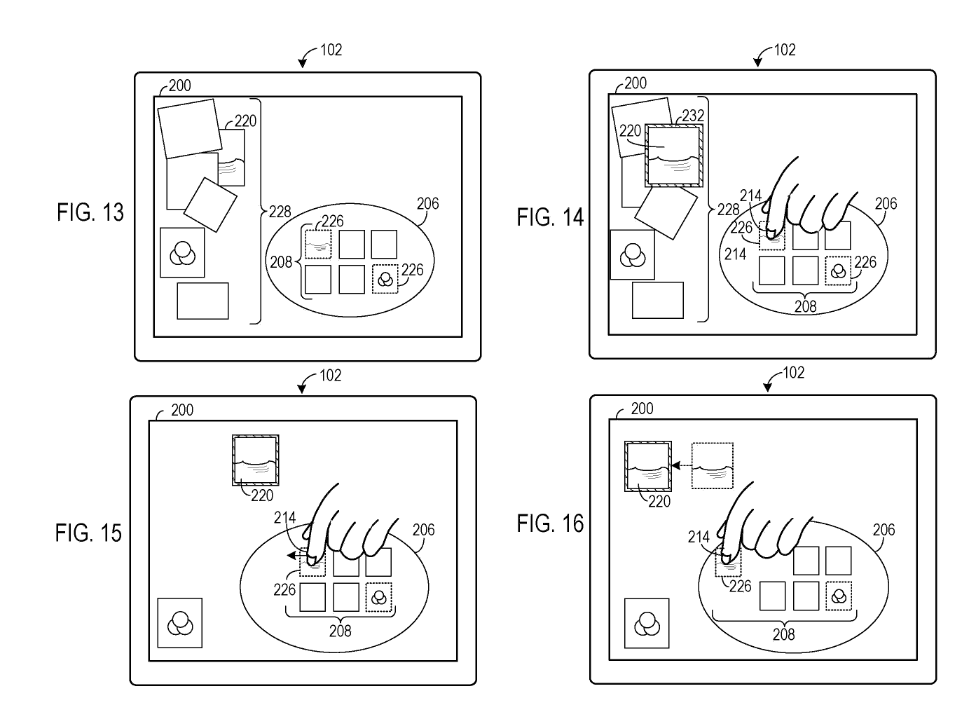

When a content item is located outside of content container 206, the specific location of the content item on the graphical user interface may be determined via interaction with the proxy view 226, a context menu associated with the content container 206, or other suitable interactions with the graphical user interface. FIGS. 13-14 illustrate an example embodiment in which the selected content item 220 is highlighted in response to a user input received via a user interface associated with the content container 206. In this way, a user may be able to visually associate content items inside the content container 206 with content items located outside of the content container 206.

FIG. 13 illustrates the grouped set of content items 208 and the ungrouped set of content items 228 displayed on the graphical user interface 200. The ungrouped set of content items 228 may include selected content item 220 and the grouped set of items may include the proxy view 226 of the selected content item 220. However, in other embodiments alternate techniques may be used to select and move a content item outside of the content container 206.

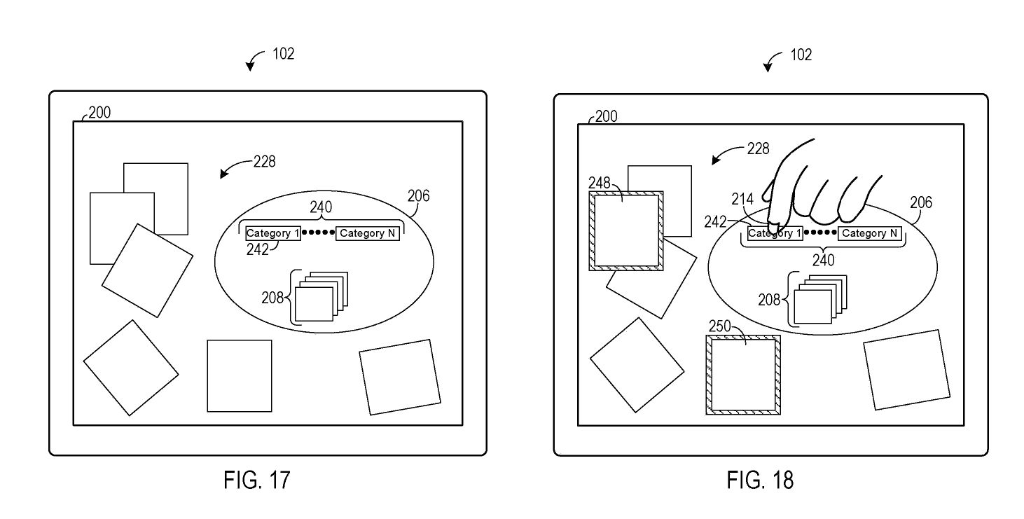

Next referring to FIG. 14, a user input may be performed via a touch input performed above the selected content item 220. In other embodiments, as illustrated in FIGS. 17-18 described below, the touch input may be performed over another user interface feature associated with the content container 206. The touch input may comprise a user placing a digit 214 or manipulator upon, or proximate (within a predetermined tolerance) to, the touch-sensitive display 102.

In response to the touch input over the proxy view 226 of the selected content item 220, the selected content item 220 is highlighted. Highlighting may comprise any visual response configured to distinguish the selected content item 220 from other ungrouped content items. In the depicted embodiment, highlighting is represented schematically via a hatched boarder 232 surrounding the selected content item 220 in FIG. 14. It will be appreciated that highlighting content items may include one or more of applying an effect on the content items, adjusting a z-order of the content item, adjusting one or more image characteristics of the content item, and moving the content item. Example effects include a shimmer effect, a light reflection effect, etc. The image characteristics may include one or more of a brightness, phase, color setting, saturation, opacity, etc. Additionally, movement of the content may include shaking an item in a manner which may be periodic about one or more axes, rotating a content item, etc. The z-order of the content item may be increased such that the content item is displayed above (e.g. on top of) other ungrouped content items. Thus highlighting enables a user to quickly and easily identify the location of an ungrouped content item amongst the ungrouped set of content item 228.

In some embodiments, highlighting also may comprise an animated movement of the selected content item 220, for example, via vibration, movement to an unoccupied portion of the user interface, etc. Further, in some embodiments, a user may move the proxy view 226 to cause movement of the selected content item 220 to help locate the selected content item 220. FIGS. 15-16 illustrates an example embodiment in which movement of the proxy view 226 of the selected content item causes movement of the selected content item 220.

As depicted, a user first touches an area over or proximate to proxy view 226 on In response to the touch gesture both the proxy view 226 of the selected content item and the selected content item 220 move in response, as illustrated in FIG. 16. Thus, a user may identify the selected content item 220 included in the ungrouped set of content items.

In some embodiments, the highlighting of the selected content item 220, illustrated in FIGS. 14 and 16, may be maintained for a duration of time after cessation of the user input (e.g. touch gesture 234).

FIGS. 17-18 illustrates a contextual menu 240 within the content container 206 in the graphical user interface 200. However, it will be appreciated, that the contextual menu 240 may be displayed in another suitable location on the graphical user interface 200, such as outside of the content container 206. The contextual menu may include a plurality of content categories 242 which are graphically displayed. The content categories 242 may correspond to various data included in, or associated with, content items, such as meta-data. The content items may be included in both the grouped set of content items 208 as well as the ungrouped set of content items 228. Each content category may include one or more content items (i.e. members). For example, the content categories may correspond to specified ranges of dates. Therefore, content items whose date of creation falls within the range of dates, stipulated by a content category, are included in that content category. In some embodiments, the content categories may be pre-determined. However, in other embodiments the content categories may be determined via a user.

A content category 244 may be selected via a touch input, or other suitable user input. The touch input may be performed above or proximate to the displayed content category 244, as illustrated in FIG. 18. The touch input may comprise a user placing a digit 214, or other manipulator, on or proximate to the touch-sensitive display 102. In response to the touch input the members (248 and 250) of the content category 242 that were previously moved out of content container 206 are highlighted. Further, any members of the content category that are located within the content container may be moved to a higher z-order in response, or otherwise highlighted within the content container 206. In this way, a user may easily identify content items included a particular content category.

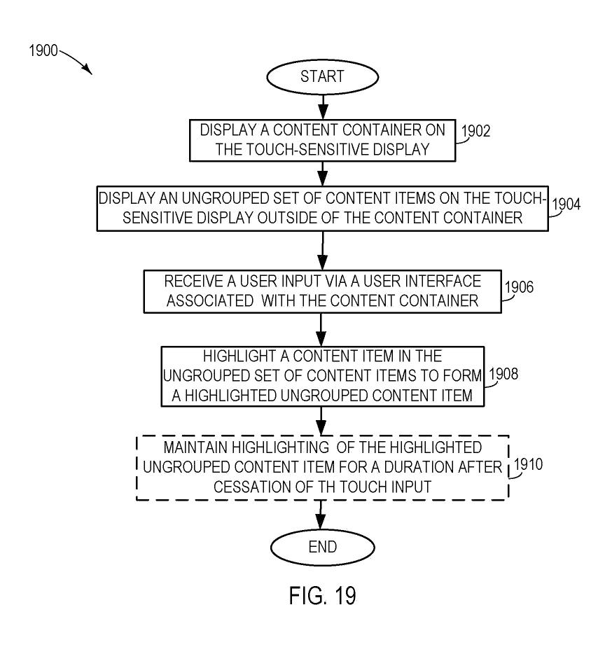

FIG. 19 illustrates an embodiment of a method 1900 for operating a graphical user interface on a computing device including a touch-sensitive display. The method 1900 may be implemented using the hardware and software components of the systems and devices described above, but alternatively may be implemented using any other suitable hardware and software components.

The method 1900 comprising, at 1902, displaying a content container on the touch-sensitive display, the content container being configured to arrange one or more content items in the content container as a grouped set of content items and to allow a user to selectively move content items into and out of the content container. In some embodiments, the content items comprise one or more of image content, video content, music content, documents, spreadsheets, text files, programs, and/or any other suitable type of content, and may have any suitable representation and/or appearance.

The grouped set of items may be arranged in various configurations within the content container. One non-limiting example configuration includes a stacked configuration. A stacked configuration may comprise two or more content items arranged according to an assigned z-order. Additionally, each content item included in the stack may be offset according to a pre-determined geometry, facilitating easy viewing of the content items contained within the stack.

Additionally, the grouped set of content items may be displayed in a grid configuration. The grid configuration may comprise two or more content items arranged in axial alignment, which may be horizontal and/or vertical. It will be appreciated that a multitude of configurations may be used and the aforementioned configurations are example in nature.

Method 1900 next comprises, at 1904, displaying an ungrouped set of content items on the touch-sensitive display outside of the content container and, at 1906, receiving a user input via a user interface associated with the content container. In some embodiments, the user input may include a touch gesture performed over or proximate to a selected content item. However, in other embodiments, the user input may be received via a contextual menu associated with (e.g. displayed within) the content container. Therefore, the selection of the content category may be received from the contextual menu. Additionally, the highlighted ungrouped content item may be a member of the content category.

Method 1900 next comprises, at 1908, highlighting a content item in the ungrouped set of content items to form a highlighted ungrouped content item in response to the user input. In some embodiments highlighting the content item in the ungrouped set of content items comprises one or more of applying an effect on the content item, adjusting a z-order of the content item, adjusting one or more image characteristics of the content item, and moving the content item, either via animation or via user-controlled movement.

In one example embodiment, the grouped set of content items may include a proxy view of the highlighted ungrouped content item. The proxy view of the content item may have different image characteristic than the ungrouped view of the content item. The image characteristics may include opacity, saturation, and brightness. Additionally, the user input may include a touch input above the proxy view of the highlighted ungrouped content item.

In some embodiments, as shown at 1910, the method may comprise maintaining highlighting of the highlighted ungrouped content item for a duration after cessation of the touch input. In some embodiments the duration may be pre-determined. After 1910 the method ends.

The above-described embodiments further allow a user to efficiently utilize inputs on a touch-sensitive display to manage, organize, and manipulate content items. It will be understood that the term “computing device” as used herein may refer to any suitable type of computing device configured to execute programs. Such computing device may include, but are not limited to, the illustrated surface computing device, a mainframe computer, personal computer, laptop computer, portable data assistant (PDA), computer-enabled wireless telephone, networked computing device, combinations of two or more thereof, etc. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that a computer-readable storage medium may be provided having program instructions stored thereon, which upon execution by a computing device, cause the computing device to execute the methods described above and cause operation of the systems described above.

It will further be understood that the embodiments of touch-sensitive displays depicted herein are shown for the purpose of example, and that other embodiments are not so limited. Furthermore, the specific routines or methods described herein may represent one or more of any number of processing strategies such as event-driven, interrupt-driven, multi-tasking, multi-threading, and the like. As such, various acts illustrated may be performed in the sequence illustrated, in parallel, or in some cases omitted. Likewise, the order of any of the above-described processes is not necessarily required to achieve the features and/or results of the example embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method for operating a graphical user interface on a computing device comprising a touch-sensitive display, the method comprising:
displaying a content container on the touch-sensitive display, the content container being configured to arrange one or more content items in the content container as a grouped set of content items and to allow a user to selectively move content items into and out of the content container;
displaying an ungrouped set of content items on the touch-sensitive display outside of the content container;
receiving a user input via a user interface associated with the content container; and
in response to the user input, highlighting a content item in the ungrouped set of content items to form a highlighted ungrouped content item.

2. The method of claim 1 wherein the content items comprise one or more of image content, video content, music content, and documents.

3. The method of claim 1, wherein receiving a user input comprises displaying a contextual menu associated with the content container and receiving a selection of a content category from the contextual menu, and wherein the highlighted ungrouped content item is a member of the content category.

4. The method of claim 3, wherein the grouped set of content items is arranged in a stacked configuration in the content container and comprises two or more content items arranged according to an assigned z-order.

5. The method of claim 3, wherein the grouped set of content items is displayed in a grid configuration.

6. The method of claim 1, wherein the grouped set of content items comprises a proxy view of the highlighted ungrouped content item, and wherein the user input comprises a touch over the proxy view of the highlighted ungrouped content item.

7. The method of claim 6, wherein the grouped set of content items is displayed in a grid configuration.

8. The method of claim 1 wherein highlighting the content item in the ungrouped set of content items comprises one or more of applying an effect on the content item, adjusting a z-order of the content item, adjusting one or more image characteristics of the content item, and moving the content item.

9. The method of claim 1, further comprising maintaining highlighting of the highlighted ungrouped content item for a duration of time after cessation of the user input.

10. A computing device, comprising:
a touch-sensitive display;
a processor; and
memory comprising code executable by the processor to:
display a content container on a graphical user interface on the touch-sensitive display;
display a grouped set of content items within the content container, the grouped set of content items including one or more content items;
receive an input requesting movement of a selected content item to a location on the touch-sensitive display outside of the content container;
in response to the input, move the selected content item out of the content container to the location outside of the content container;
receive a user input via a user interface associated with the content container; and
in response, highlight the selected content items.

11. The computing device of claim 10, wherein the code is executable to display a proxy view of the selected content item within the content container after movement of the selected content item out of the content container.

12. The computing device of claim 11 wherein the proxy view comprises an alteration of one or more of an opacity, saturation, and brightness in comparison to the selected content item.

13. The computing device of claim 12 wherein the grouped set of content items is arranged in a grid configuration.

14. The computing device of claim 10, wherein the user input comprises a selection of a content category from a contextual menu associated with the content container, and wherein the selected content item is a member of the content category.

15. The computing device of claim 14 wherein highlighting a content item includes one or more of applying an effect on the content item, adjusting a z-order of the content item, adjusting one or more image characteristics of the content item, and moving the content item.

16. The computing device of claim 15 wherein the user input is a touch gesture and moving the content item includes movement of the content item directly corresponding to the movement of the touch gesture.

17. The computing device of claim 10 wherein the grouped set of content items is arranged in a stacked configuration in which one or more items are arranged according to an assigned z-order.

18. A computing device, comprising:
a touch-sensitive display;
a processor; and
memory comprising code executable by the processor to:
display a content container on a graphical user interface on the touch-sensitive display;
display a grouped set of content items within the content container;
display an ungrouped set of items on the graphical user interface outside of the content container;
display in the content container a proxy view of a selected ungrouped content item, the proxy view of the selected ungrouped content item corresponding to a selected ungrouped content item located outside of the content container, and the proxy view of the selected ungrouped content item comprising one or more of a different opacity, saturation, and/or brightness than the selected ungrouped content item;
receive a touch input over a representation of the selected ungrouped content item in the content container; and
in response, highlight the selected ungrouped content item.

19. The computing device of claim 18 further comprising code executable to display a category menu including one or more content categories, receive a touch input over a selected content category, and in response, highlight any ungrouped content items that are members of the selected content category.

20. The computing device of claim 18 wherein highlighting the selected ungrouped content item includes one or more of applying an effect on the content item, adjusting a z-order of the content item, adjusting one or more image characteristics of the content item, and moving the content item.
